(19) United States
(12) Patent Application Publication
(10) Pub. No.: US 2026/0147614 A1
(43) Pub. Date: May 28, 2026

(54) MULTI-STAGE SCHEDULING FOR WIRELESS PROTOCOLS

(71) Applicant: Silicon Laboratories Inc., Austin, TX (US)

(72) Inventors: Hasan Ali Stationwala, Hyderabad (IN); Jitesh Rachamadugu, Hyderabad (IN); Raghu Ram Sista, Hyderabad (IN)

(21) Appl. No.: 18/959,797

(22) Filed: Nov. 26, 2024

(51) Int. Cl. G06F 9/48; G06F 1/329; H04W 52/02

(52) U.S. Cl. CPC G06F 9/4887; G06F 1/329; G06F 9/4893; H04W 52/0261

(57) ABSTRACT

In one aspect, a method includes: scheduling, in a first scheduler that executes on a first processor of a wireless device, a first non-periodic procedure of a wireless protocol for execution on the first processor; and scheduling, in a second scheduler that executes on a second processor of the wireless device, a first periodic procedure of the wireless protocol for execution on the second processor.

### BACKGROUND

As ever more devices become connected together wirelessly, difficulties arise in maintaining efficient communications. This is especially so, when a given wireless device may be communicating with different partners via different wireless protocols.

Typically, each wireless protocol performs its transmit and receive operations according to a particular scheduling. As a particular example, low power wireless (LPW) communication protocols such as Bluetooth Classic and Bluetooth Low Energy (BLE) implement a concept of procedures while communicating with peer devices, and multiple procedures compete for radio time. These protocols implement an internal scheduler that arbitrates between different procedures to select a highest priority procedure to use underlying radio hardware. However, an increasing number of procedures and various factors, including activity of other wireless protocols, can change priority of such procedures, and scheduling becomes very complicated, with little tolerance for latencies.

### SUMMARY OF THE INVENTION

In one aspect, a method includes: scheduling, in a first scheduler that executes on a first processor of a wireless device, a first non-periodic procedure of a wireless protocol for execution on the first processor; and scheduling, in a second scheduler that executes on a second processor of the wireless device, a first periodic procedure of the wireless protocol for execution on the second processor.

In an implementation, the method further comprises sending the first periodic procedure from the first scheduler to the second scheduler. Sending the first periodic procedure from the first scheduler to the second scheduler may include sending scheduling information comprising a start time and a periodicity of the first periodic procedure.

In one implementation, the method further comprises after sending the first periodic procedure from the first scheduler to the second scheduler, causing the first processor to enter into a first low power state. The method may also include: causing the second processor to enter into a second low power state; and causing the second processor to exit the second low power state to execute a scheduled iteration of the first periodic procedure. The method further may include: causing the first processor to remain in the first low power state for at least a duration of the first periodic procedure; and causing the second processor to enter into a second low power state between iterations of the first periodic procedure.

In one implementation, the method further includes sending a second non-periodic procedure of the wireless protocol from the first scheduler to the second scheduler, to cause the second scheduler to schedule the second non-periodic procedure on the second processor. The method may also include: arbitrating, in the second scheduler, between the second non-periodic procedure and the first periodic procedure to identify a selected procedure and a non-selected procedure; and scheduling the selected procedure for execution on the second processor. The method further comprises updating a priority of the non-selected procedure. The method further comprises when the non-selected procedure is the second non-periodic procedure, scheduling the second non-periodic procedure after the first periodic procedure concludes. The method may further include interleaving execution of the first periodic procedure and the second non-periodic procedure on the second processor.

In another aspect, an apparatus includes: a host processor to execute a first portion of a protocol stack of a first wireless protocol, the first portion of the protocol stack comprising a first scheduler, the first scheduler to schedule non-periodic procedures of the first wireless protocol on the host processor; and a co-processor coupled to the host processor, the co-processor to execute a second portion of the protocol stack of the first wireless protocol, the second portion of the protocol stack comprising a second scheduler to schedule periodic procedures of the first wireless protocol pm the co-processor.

In one implementation, the host processor comprises at least one core and the co-processor comprises a low power radio co-processor. In an implementation: the first portion of the protocol stack comprises one or more link controllers; and the second portion of the protocol stack comprises a mailbox interface to communicate with a radio abstraction layer to execute on the co-processor.

In an implementation, the host processor is further to execute a protocol stack for a second wireless protocol, the first wireless protocol having lower power consumption than the second wireless protocol. The execution of the protocol stack for the second wireless protocol is to cause the first scheduler to be triggered non-deterministically. The host processor may be configured to execute a first non-periodic procedure of the first wireless protocol comprising an asynchronous data transfer; and the co-processor may be configured to execute a first periodic procedure of the first wireless protocol comprising a synchronous data transfer.

In another aspect, a method comprises: scheduling, via a multi-level scheduler, a first non-periodic procedure of a wireless protocol to execute on a first processor of the wireless device; and scheduling, via the multi-level scheduler, a first periodic procedure of the wireless protocol to execute on a second processor of the wireless device, wherein the first processor is in a low power state during at least a portion of the execution of the first periodic procedure on the second processor.

In an implementation, the method further comprises: arbitrating between a second non-periodic procedure and the first periodic procedure to identify a selected procedure and a non-selected procedure; and scheduling, via the multi-level scheduler, the selected procedure to execute on the second processor, the second processor comprising a co-processor and the first processor comprising a host processor. The method further comprises scheduling the first periodic procedure to execute on the second processor in an interleaved manner with a second non-periodic procedure to execute on the second processor.

### BRIEF DESCRIPTION OF THE DRAWINGS

FIG. 1 is a block diagram of subsystems present in a wireless device in accordance with an embodiment.

FIG. 2 a high level flow diagram illustrating scheduling operations in accordance with an embodiment.

FIG. 3 is a flow diagram of a method in accordance with an embodiment.

FIG. 4 is a flow diagram of a method in accordance with another embodiment.

FIG. 5 is a method in accordance with yet another embodiment.

FIG. 6 is a block diagram of a device in accordance with an embodiment.

FIG. 7 is a block diagram of a representative integrated circuit in accordance with an embodiment.

FIG. 8 is a high level diagram of a network in accordance with an embodiment.

### DETAILED DESCRIPTION

In various embodiments, scheduling operations for wireless activity in a given wireless device can be performed using a multiple level scheduling approach in which certain scheduling operations are performed in a scheduler implemented within a host subsystem, and other scheduling operations are performed within another scheduler implemented within a co-processor. To this end, embodiments provide scheduling circuitry associated both with a main processor of a wireless device such as a central processing unit (CPU) and additional processors such as a co-processor, which may be implemented as a microcontroller (MCU) and/or network processor (NWP).

At a high level, in one embodiment, a first scheduler implemented in a host subsystem includes resource exhaustive and configurable scheduling activities. In turn, a second scheduler present in a LPW subsystem performs scheduling of low power and highly periodic activities. In this way, computation for scheduling performed within the host subsystem can be reduced since part of it is offloaded to the LPW subsystem.

In general, procedures can be identified as periodic or non-periodic, with non-periodic activities being scheduled within the first scheduler present in the host subsystem, and periodic activities being scheduled in the LPW subsystem. In one or more implementations, a configurable number (e.g., one or a small number) of non-periodic operations also may be scheduled in the second scheduler.

In such implementations, arbitration between multiple non-periodic roles can be performed in the first scheduler. Such non-periodic roles are typically not affected by jitters in system delay, and thus can be safely scheduled within the host subsystem. In contrast, periodic procedures

In turn, periodic roles may be scheduled within the second scheduler within the LPW subsystem. To this end, the first scheduler can pass procedure information and scheduling information such as start time, periodicity and priority to the second scheduler. As such, the second scheduler is aware of all possible periodic activities at any point in time. Such periodic activities may be stored in a queue, e.g., a periodic queue that is sorted by time. In this way, a read pointer for the periodic queue can always point to a next activity to be executed. In the case of a conflict, an activity with a higher priority remains in the periodic queue, and an activity having a lower priority is instead scheduled for its next instance.

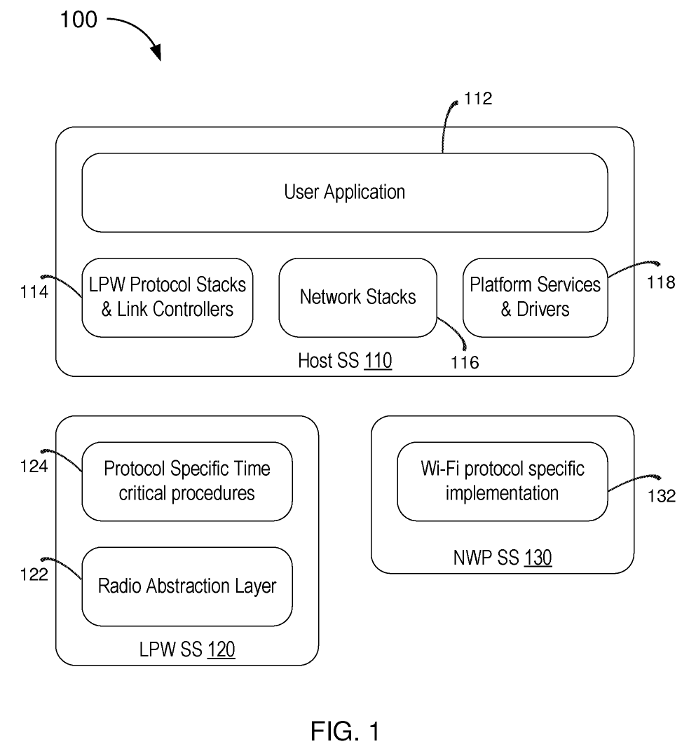

Referring now to FIG. 1, shown is a block diagram of subsystems present in a wireless device in accordance with an embodiment. As shown in FIG. 1, wireless device 100 may be any type of wireless device, ranging from small Internet of Things (IoT) devices, access points, smartphones, tablet computers, and so forth, to larger devices, such as laptop computers or so forth. In the high level view shown in FIG. 1, an arrangement of firmware/software subsystems present within a wireless device are shown. Understand that such subsystems may execute on one or more processors, such as a host processor and/or additional co-processors, such as may be present in a multi-protocol transceiver, e.g., implemented as part of a system on a chip (SoC) or as a separate integrated circuit (IC) included in wireless device 100. And note that the firmware/software itself may be implemented as instructions stored in a non-transitory storage medium that when executed cause such processors to perform instructed operations.

In the high level view shown in FIG. 1, wireless device 100 includes a host subsystem 110, a LPW subsystem 120, and a NWP subsystem 130. Starting first with host subsystem 110, a plurality of user applications 112 may execute and seek to use various services, including wireless communication, networking or so forth. As such, applications 112 communicate with LPW protocol stacks and link controller 114, network stacks 116 and platform services and drivers 118 (all generically stacks, services or drivers). Platform services 118 may include a variety of platform services such as an operating system (OS), radio interface abstraction layer (RAIL), and others. Understand that supported LPW protocols may include Bluetooth Classic, BLE, IEEE 802.15.4, among others.

To effect communication according to such LPW protocols, stacks 114 communicate with LPW subsystem 120, which, as shown, includes protocol specific time critical procedures 124 and a radio abstraction layer 122. In an embodiment, procedures 124 may include protocol specific procedures that are time critical and thus are co-located with radio abstraction layer 122. As further shown in FIG. 1, stacks 116 may communicate with NWP subsystem 130, which, as shown, includes Wi-Fi protocol specific procedures 132. In an embodiment, network stacks 116 may include a variety of networking stacks such as transmission control protocol/Internet protocol (TCP/IP), secure sockets layer (SSL), and so forth.

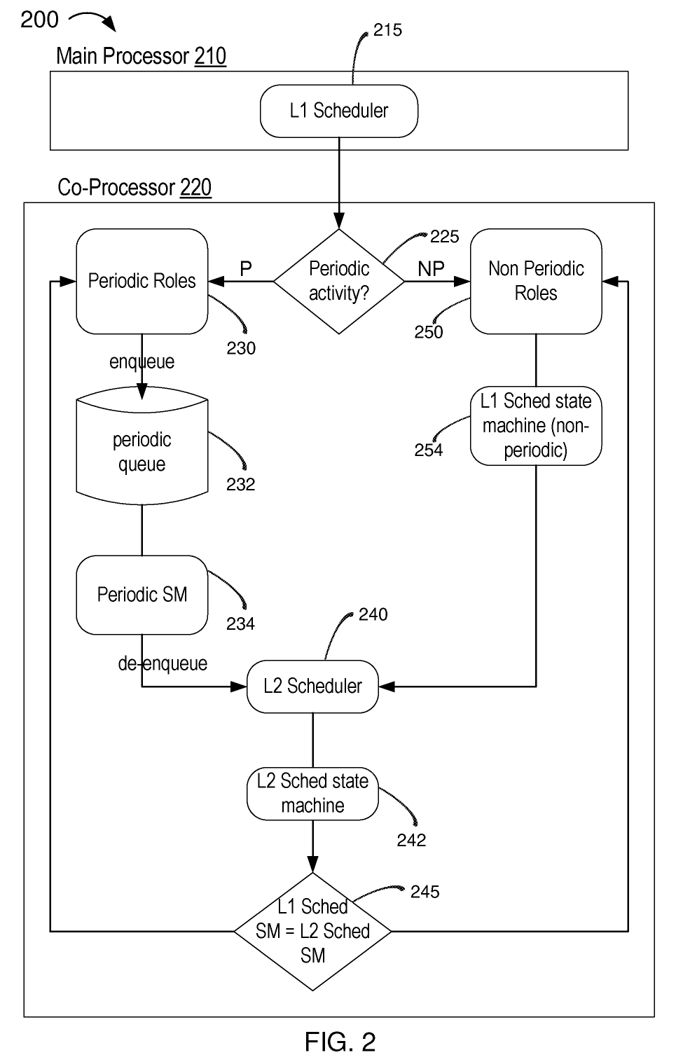

Referring now to FIG. 2, shown is a high level flow diagram illustrating scheduling operations in accordance with an embodiment. As shown in FIG. 2, method 200 is a method for scheduling operations according to a multi-level scheduling approach. As illustrated, method 200 is performed via a first scheduler (referred to as a level 1 (L1) scheduler) 215 implemented in a main processor 210, e.g., a CPU of an SoC, and a second scheduler (referred to as a level 2 (L2) scheduler) 240 implemented in a coprocessor 220, which may be realized as a MCU and/or NWP of the SoC.

In general, non-periodic activities may be scheduled within L1 scheduler 215. However, FIG. 2 illustrates an implementation in which it is possible for a small number (e.g.,1) of non-periodic roles to be scheduled within coprocessor 220.

In the high level shown, L1 scheduler 215 provides roles to coprocessor 220, which determines (at diamond 225) whether a given role is for a periodic or non-periodic activity. For periodic roles, control passes to block 230, which is used to enqueue such roles and their relevant information into a periodic queue 232. As shown, a periodic state machine (SM) 234 may operate to dequeue a given role from periodic queue 232, e.g., based upon a read pointer that points to the next role to be scheduled.

This dequeued periodic role is provided to L2 scheduler 240, which schedules the operations for execution via an L2 scheduler state machine 242. Next, it is determined at diamond 245, whether a state of this L2 scheduler state machine matches the state of an L1 scheduler state machine 254, which handles a given non-periodic role that is passed via block 250. Based on this determination, a priority of a non-selected procedure may be updated (e.g., incremented), and fed back for another scheduling interaction within L2 scheduler 240. Although shown at this high level in the embodiment of FIG. 2, many variations and alternatives are possible.

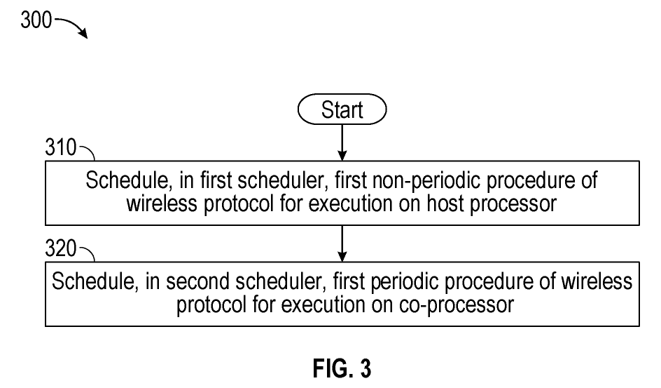

Referring now to FIG. 3, shown is a flow diagram of a method in accordance with an embodiment. More specifically, as shown in FIG. 3, method 300 is a high level method for performing a multi-level scheduling process for wireless tasks. In the particular implementation shown, a two-level scheduling process is illustrated. Understand however that in other implementations, greater than two levels of scheduling may be performed. In embodiments, method 300 may be performed by a scheduler, which can be segmented into multiple levels and can be executed on one or more processors of a wireless device. As such, method 300 can be performed by hardware circuitry of the wireless device, including one or more processors, in combination with firmware and/or software. To this end, the wireless device may include a non-transitory storage medium such as a flash memory or other non-volatile memory that stores instructions of the firmware and/or software for execution by these processors.

As illustrated, method 300 begins by scheduling, in a first scheduler, a first non-periodic procedure of a wireless protocol (block 310). This first non-periodic procedure can be scheduled to execute on a host processor, such as a MCU of a SoC. Understand that in different implementations, a wide variety of non-periodic procedures can be scheduled and executed. As examples, such non-periodic procedure may include an asynchronous connection-less (ACL) file transfer operations where delays are not of significance, and/or discovery and connection process in Bluetooth Classic.

Still referring to FIG. 3, next at block 320, a first periodic procedure of the wireless protocol may be scheduled, in a second scheduler. This first periodic procedure can be scheduled to execute on a co-processor, such as a LPW co-processor of the SoC. Understand that in different implementations, a wide variety of periodic procedures can be scheduled and executed. As a particular example, the periodic procedure may be a sniff procedure formed of specific time instances (e.g., pre-negotiated between two devices) where devices check for availability of each other.

Note that while these different procedures are described to be executed on different processors, namely, a host processor and a co-processor, in some implementations these procedures can be executed on a common processor, which may include separate hardware resources for execution of periodic and non-periodic tasks. Further, although the scheduling is described as proceeding in a particular order, namely first scheduling in the first scheduler a non-periodic procedure and thereafter scheduling in the second scheduler a periodic procedure, other situations are possible. For example in other use cases, scheduling of periodic procedures via the second scheduler can occur prior to scheduling of a given non-periodic procedure in the first scheduler.

Also, understand that while not shown in the high level of FIG. 3, in some cases the first scheduler may pass this first periodic procedure to the second scheduler for its scheduling. Also, in some cases this periodic procedure can be triggered as part of a larger, non-periodic procedure, such as an asynchronous procedure, which leads to message exchanges. These messages are parsed by a stack in the host subsystem, which informs the first scheduler to schedule this periodic procedure in the second scheduler. In another case, handling of a first scheduler-scheduled procedure in the co-processor may trigger scheduling of a periodic activity in the co-processor without involving the first scheduler. Although shown at this high in the embodiment of FIG. 3, many variations and alternatives are possible.

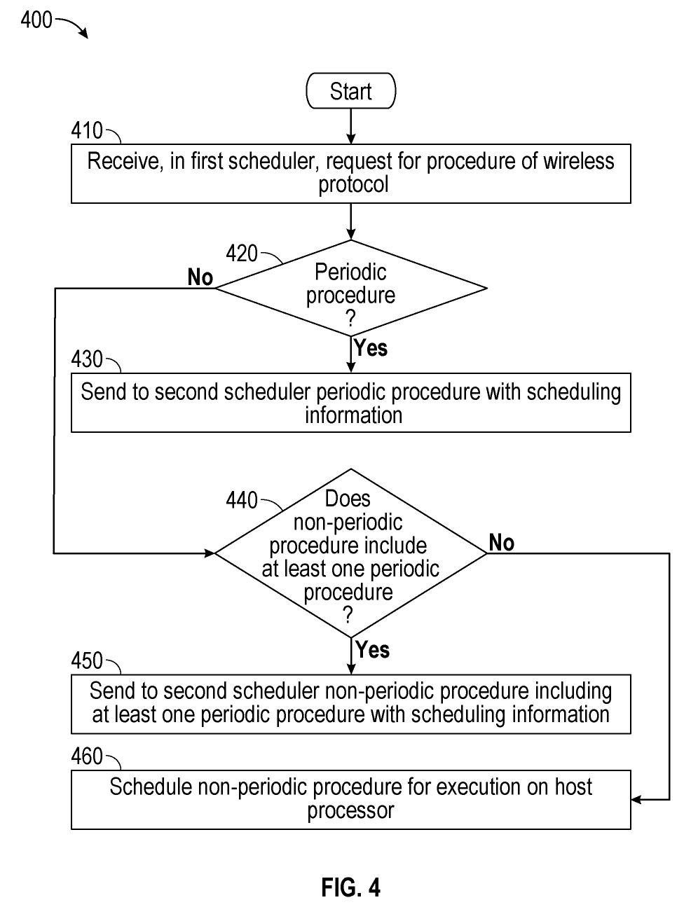

Referring now to FIG. 4, shown is a flow diagram of a method in accordance with another embodiment. More specifically, method 400 of FIG. 4 is a method for scheduling tasks performed by a first scheduler. As discussed above, this first scheduler may execute on a host processor of a given wireless device.

As illustrated, method 400 begins by receiving, in the first scheduler, a request for a procedure of a wireless protocol (block 410). This request may be issued by an application, e.g., due to a user activity or based on another application requirement. At diamond 420 it is determined whether this received request is for a periodic procedure. If so, control passes to block 430, where the first scheduler sends to the second scheduler the periodic procedure with scheduling information. In one embodiment, this scheduling information may include a start time, a periodicity, and a priority of the periodic procedure. Thus at this point, the first scheduler is relieved of any responsibility for scheduling for this periodic procedure. In this way, it is possible for the first scheduler and the processor on which it executes (e.g., a host processor) to enter into longer and deeper low power states, or attend to other tasks.

Still referring to FIG. 4, instead if the received procedure is a non-periodic procedure, control passes to diamond 440 to determine whether in turn this periodic procedure includes at least one periodic procedure, such as may be the case for an ACL data transfer (e.g., for Bluetooth Classic, where packet transmit can be attempted for every alternate slot). Scheduling is best effort, and the packet can be transmitted at any slot available, hence asynchronously. In this instance the non-periodic procedure including at least one periodic procedure is sent to the second scheduler for scheduling, along with its associated scheduling information, such as described above (block 450).

Otherwise when it is determined that the non-periodic procedure does not include at least one periodic procedure, control passes to block 460, where it may be scheduled for execution on the host processor. This is so, since in this situation, the procedure may benefit from greater computing resources of the host processor which can execute the task and then return to a low power state. Understand while shown at this high level in the embodiment of FIG. 4, many variations and alternatives are possible.

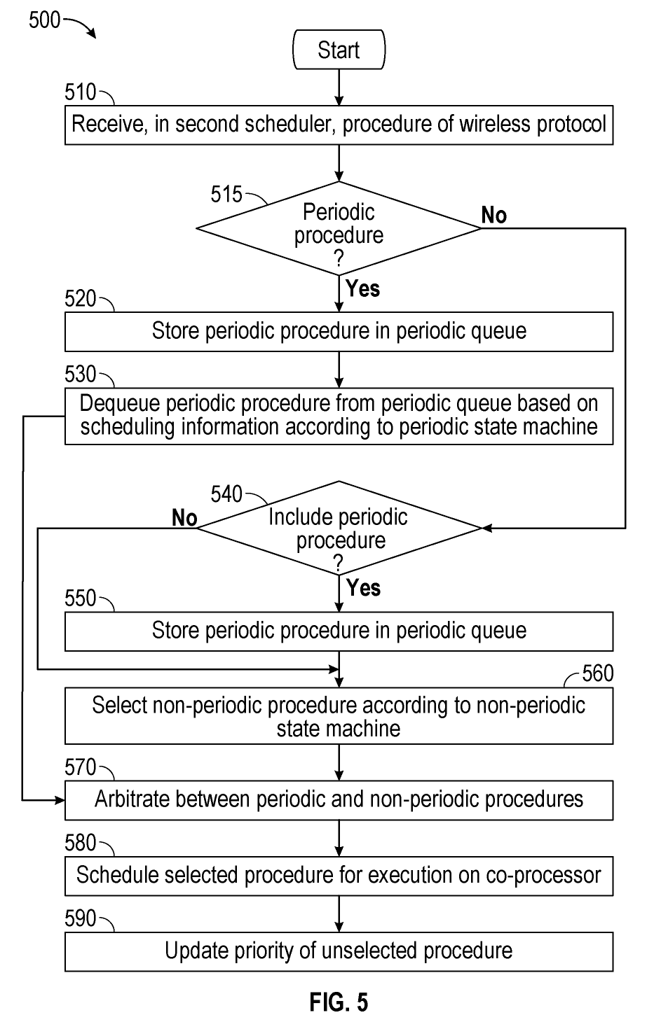

Referring now to FIG. 5, shown is a flow diagram of a method in accordance with yet another embodiment. More specifically, method 500 of FIG. 5 is a method for scheduling tasks performed by a second scheduler. As discussed above, this second scheduler may execute on a co-processor of a given wireless device.

As illustrated, method 500 begins by receiving, in the second scheduler, a procedure of a wireless protocol (block 510). This procedure is received from the first scheduler, and can be a periodic or non-periodic procedure. As further shown in FIG. 5, when the received procedure is a periodic procedure (as determined at diamond 515), control passes to block 520, where this periodic procedure is stored into a periodic queue. Then, at block 530, a given periodic procedure is dequeued from the queue. This dequeuing of the periodic procedure may be based on scheduling information and can be performed according to a periodic state machine. This scheduling information, which is used to determine a given one of potentially multiple periodic procedures for dequeuing, can indicate a relative priority for the different procedures, along with timing requirements, such as a periodicity of when the given task is to occur, e.g., according to a given periodic interval.

Still referring to FIG. 5, control passes to block 570, where an arbitration may be performed in the second scheduler between a given periodic procedure and a non-periodic procedure (if present). Embodiments are not limited in this regard, but understand that such arbitration may be performed according to a round robin arbitration, a priority-based arbitration or in another manner. The selected procedure then may be scheduled for execution on the co-processor (block 580). Finally, at block 590, the priority of the unselected procedure may be updated. For example, whichever procedure was not selected can have its priority increased to a higher level, such that it becomes more likely for that procedure to be selected, e.g., in a next arbitration cycle.

Still referring to FIG. 5, if instead at diamond 515, it is determined that a non-periodic procedure is received in the second scheduler, control passes to diamond 540 to determine whether it includes at least one periodic procedure. If so, at block 550, this periodic procedure and any associated scheduling information for the periodic procedure can be stored into the periodic queue. Then at block 560, the non-periodic procedure can be selected according to a non-periodic state machine. On selection, the non-periodic procedure is provided for arbitration, which proceeds at block 570, discussed above. Although shown at this high level in the embodiment of FIG. 5, many variations and alternatives are possible.

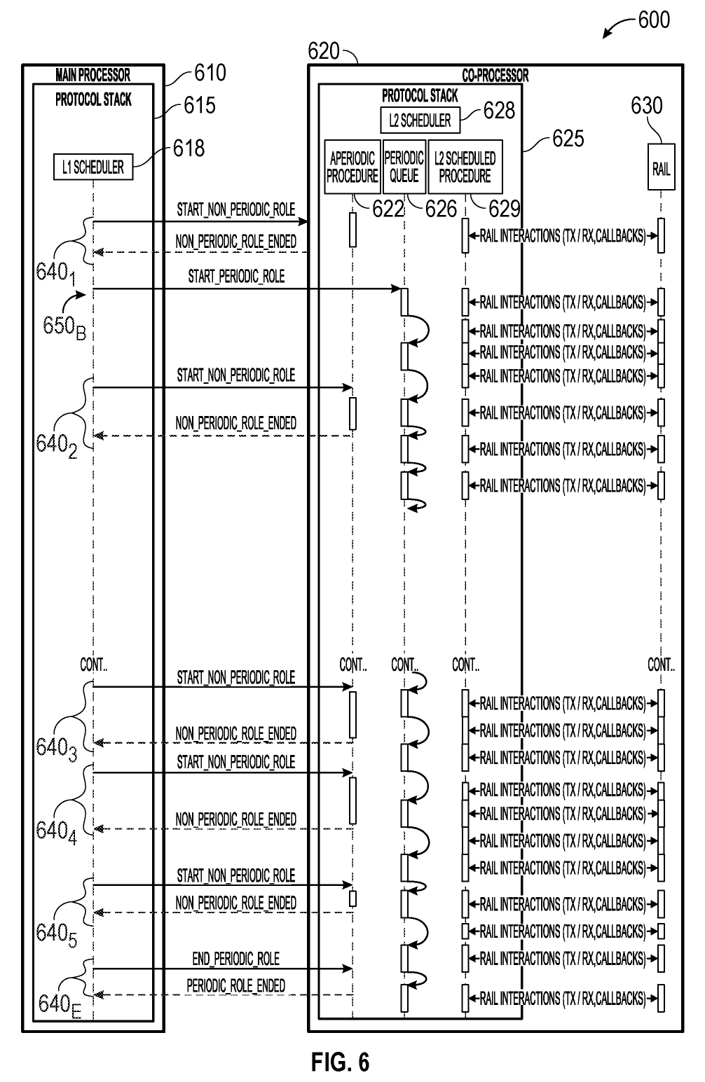

Referring now to FIG. 6, shown is a block diagram of a device in accordance with an embodiment. More specifically, as shown in FIG. 6, device 600 is a wireless device that, in the high level view of FIG. 6, includes a main processor 610, such as a given host processor (e.g., CPU, MCU or so forth) and a co-processor 620, which in an embodiment may be implemented as a low power processor, such as a RISC-V core. As shown, a wireless protocol stack can be segmented such that a first portion of the protocol stack is implemented within main processor 610 as protocol stack 615, and a second portion of the protocol stack is implemented within co-processor 620 as protocol stack 625. Within protocol stack 615 is an L1 scheduler 618, which may schedule non-periodic procedures and further can send both selected non-periodic procedures and periodic procedures for scheduling within an L2 scheduler 628, itself implemented within the second portion of the protocol stack implemented within co-processor 620, namely, protocol stack 625.

As shown, L1 scheduler 618 may send at least certain non-periodic roles to co-processor 620 (illustrated as non-periodic roles 640₁₋₅). Accordingly, protocol stack 625 may execute various aperiodic procedures 622 in response to these incoming roles.

As further shown, L1 scheduler 618 also provides a periodic role 650_{B} to co-processor 620. As shown, periodic role 650_{B} is stored in a periodic queue 626 and is scheduled via L2 scheduler 628 to intermittently execute, e.g., according to a given periodicity. Note that in some usage situations, after the periodic role is sent to co-processor 620, host processor 610 may enter into a low power state, which may persist for a duration of the periodic role execution (or at least a portion of the duration, or even longer than the duration) on co-processor 620. In addition, during iterations of the periodic role execution, co-processor 620 also may enter into a low power state. In some cases, host processor 610 may enter into deeper and longer low power states than co-processor 620.

With scheduling in accordance with an embodiment, greater power savings may be realized. This is so, since scheduling periodic tasks within co-processor 620 allows deeper power state capabilities within host processor 610. For example, wireless device 600 can be expected to remain in a sniff state for several minutes if not hours. In this state, wireless device 600 may wake up every 100-200 milliseconds just to exchange a NULL packet and enter a power saving state again. Without an embodiment, host processor 610 would be required to schedule the sniff procedure, and, thus would be required to be woken up, which is additional power drain. Instead for the duration of this sniff state, host processor 610 may remain in a given (preferably deeper) low power state. And, co-processor 620 itself could enter in to a given low power state between iterations of this NULL packet communication.

Still referring to FIG. 6, actual underlying tasks may be performed via a radio abstraction interface layer (RAIL) 630, which also executes within co-processor 620. In at least one embodiment, co-processor 620 (and/or L2 scheduler 628) includes a mailbox interface to communicate with RAIL 630, where actual transmit/receive operations are performed.

Note that during operation, both periodic tasks and a non-periodic task may be scheduled in a co-mingled manner. Stated another way, a non-periodic task can be punctured or interleaved. With this punctured scheduling, during the overall execution of a punctured aperiodic task, one or more iterations of at least one periodic task can be scheduled. Although shown at this high level in the embodiment of FIG. 6, many variations and alternatives are possible.

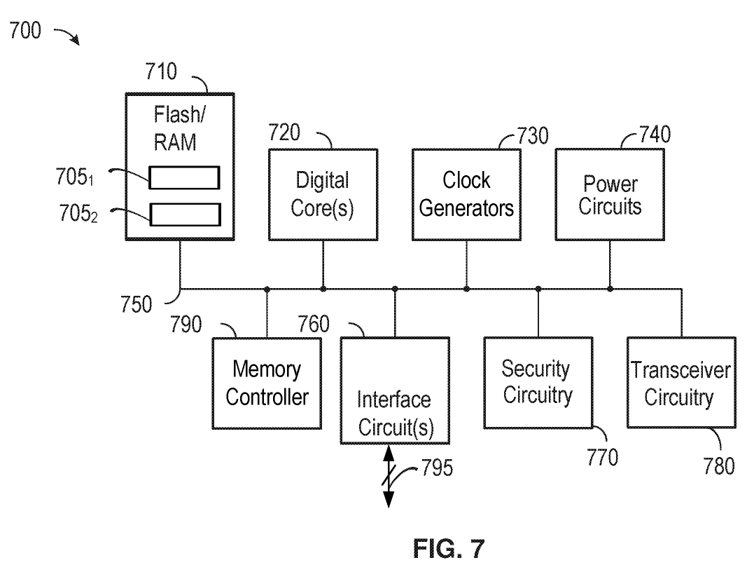

Referring now to FIG. 7, shown is a block diagram of a representative integrated circuit 700 that includes a multi-level scheduler as described herein. In the embodiment shown in FIG. 7, integrated circuit 700 may be, e.g., a multi-mode wireless transceiver that may operate according to one or more wireless protocols (e.g., Wi-Fi, Bluetooth, BLE, IEEE 802.15.4, Matter and/or Zigbee, among others) or other device that can be used in a variety of use cases. In one or more embodiments, the circuitry of integrated circuit 700 shown in FIG. 7 may be implemented on a single semiconductor die or implemented on separate dies for wireless communication, MCU compute, external flash and/or other IP blocks needed to perform a variety of functionalities.

Integrated circuit 700 may be included in a range of devices, but for purposes of discussion, it may be incorporated into an IoT device. In the embodiment shown, integrated circuit 700 includes a memory system 710 which in an embodiment may include volatile storage, such as RAM and non-volatile memory such as a flash memory. The flash memory is a non-transitory storage medium that can store instructions and data. In embodiments, this storage may store code 705₁ for a first scheduler, which may execute on a main or host processor (implemented in at least one core of one or more digital cores 720), and code 705₂ for a second scheduler, which may execute on a co-processor (implemented in at least one core of one or more digital cores 720), as described herein. Integrated circuit 700 also may include a memory controller 790.

Memory system 710 couples via a bus 750 to digital cores 720, which may include one or more cores, co-processors, and/or microcontrollers that act as processing units of the integrated circuit as described herein. In turn, digital cores 720 may couple to clock generators 730 which may provide one or more phase locked loops or other clock generator circuitry to generate various clocks for use by circuitry of the IC.

As further illustrated, IC 700 further includes power circuitry 740. Additional circuitry may be present depending on particular implementation to provide various functionality and interaction with external devices. Such circuitry may include interface circuitry 760 which provides a digital communication interface with additional circuitry that couples to IC 700 via a link 795. IC 700 also may include security circuitry 770 to perform wireless security techniques.

In addition, as shown in FIG. 7, transceiver circuitry 780 may be provided to enable transmission and reception of wireless signals, e.g., according to one or more of a local area or wide area wireless communication scheme, such as Matter, Zigbee, Bluetooth, BLE, IEEE 802.11, IEEE 802.15.4, cellular communication or so forth. Understand while shown with this high level view, many variations and alternatives are possible.

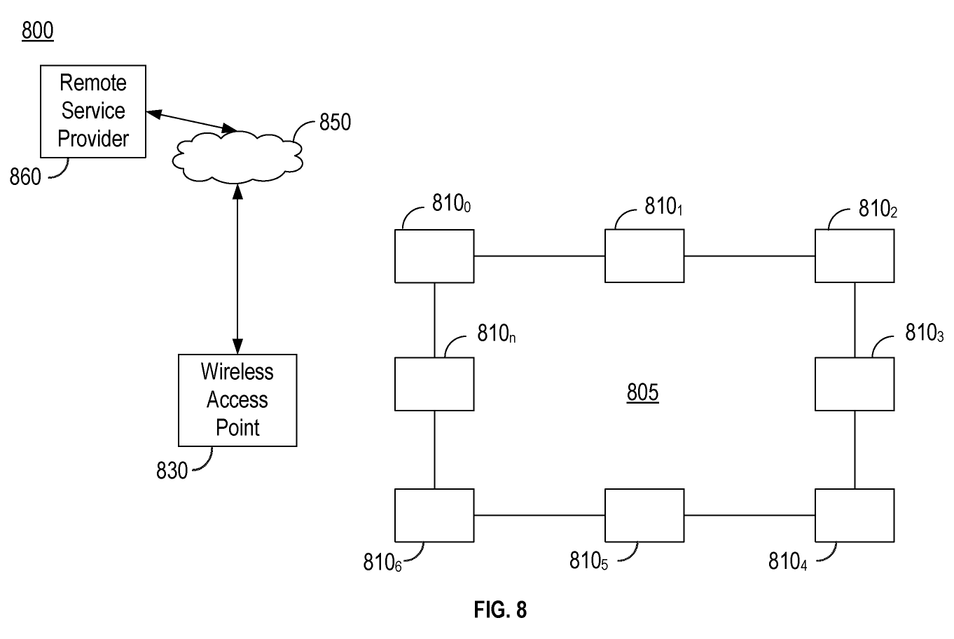

ICs such as described herein may be implemented in a variety of different devices as described above. Referring now to FIG. 8, shown is a high level diagram of a network in accordance with an embodiment. As shown in FIG. 8, a network 800 includes a variety of devices, including IoT devices which may include multi-level wireless protocol schedulers as described herein, access points and remote service providers.

In the embodiment of FIG. 8, a wireless mesh network 805 is present, e.g., in a building having multiple wireless devices 810₀₋ₙ. As shown, wireless devices 810, which may be IoT devices having multi-level wireless protocol schedulers, couple to an access point 830 that in turn communicates with a remote service provider 860 via a wide area network 850, e.g., the Internet. Understand while shown at this high level in the embodiment of FIG. 8, many variations and alternatives are possible.

While the present disclosure has been described with respect to a limited number of implementations, those skilled in the art, having the benefit of this disclosure, will appreciate numerous modifications and variations therefrom. It is intended that the appended claims cover all such modifications and variations.

What is claimed is:

1. A method comprising:
scheduling, in a first scheduler that executes on a first processor of a wireless device, a first non-periodic procedure of a wireless protocol for execution on the first processor; and
scheduling, in a second scheduler that executes on a second processor of the wireless device, a first periodic procedure of the wireless protocol for execution on the second processor.

2. The method of claim 1, further comprising sending the first periodic procedure from the first scheduler to the second scheduler.

3. The method of claim 2, wherein sending the first periodic procedure from the first scheduler to the second scheduler comprises sending scheduling information comprising a start time and a periodicity of the first periodic procedure.

4. The method of claim 2, further comprising after sending the first periodic procedure from the first scheduler to the second scheduler, causing the first processor to enter into a first low power state.

5. The method of claim 4, further comprising:
causing the second processor to enter into a second low power state; and
causing the second processor to exit the second low power state to execute a scheduled iteration of the first periodic procedure.

6. The method of claim 4, further comprising:
causing the first processor to remain in the first low power state for at least a duration of the first periodic procedure; and
causing the second processor to enter into a second low power state between iterations of the first periodic procedure.

7. The method of claim 1, further comprising sending a second non-periodic procedure of the wireless protocol from the first scheduler to the second scheduler, to cause the second scheduler to schedule the second non-periodic procedure on the second processor.

8. The method of claim 7, further comprising:
arbitrating, in the second scheduler, between the second non-periodic procedure and the first periodic procedure to identify a selected procedure and a non-selected procedure; and
scheduling the selected procedure for execution on the second processor.

9. The method of claim 8, further comprising updating a priority of the non-selected procedure.

10. The method of claim 8, further comprising when the non-selected procedure is the second non-periodic procedure, scheduling the second non-periodic procedure after the first periodic procedure concludes.

11. The method of claim 7, further comprising interleaving execution of the first periodic procedure and the second non-periodic procedure on the second processor.

12. An apparatus comprising:
a host processor to execute a first portion of a protocol stack of a first wireless protocol, the first portion of the protocol stack comprising a first scheduler, the first scheduler to schedule non-periodic procedures of the first wireless protocol on the host processor; and
a co-processor coupled to the host processor, the co-processor to execute a second portion of the protocol stack of the first wireless protocol, the second portion of the protocol stack comprising a second scheduler to schedule periodic procedures of the first wireless protocol pm the co-processor.

13. The apparatus of claim 12, wherein the host processor comprises at least one core and the co-processor comprises a low power radio co-processor.

14. The apparatus of claim 12, wherein:
the first portion of the protocol stack comprises one or more link controllers; and
the second portion of the protocol stack comprises a mailbox interface to communicate with a radio abstraction layer to execute on the co-processor.

15. The apparatus of claim 12, wherein the host processor is further to execute a protocol stack for a second wireless protocol, the first wireless protocol having lower power consumption than the second wireless protocol.

16. The apparatus of claim 15, wherein the execution of the protocol stack for the second wireless protocol is to cause the first scheduler to be triggered non-deterministically.

17. The apparatus of claim 12, wherein:
the host processor is to execute a first non-periodic procedure of the first wireless protocol comprising an asynchronous data transfer; and
the co-processor is to execute a first periodic procedure of the first wireless protocol comprising a synchronous data transfer.

18. A computer-readable medium comprising instructions that when executed by at least one processor of a wireless device cause the wireless device to perform a method comprising:
scheduling, via a multi-level scheduler, a first non-periodic procedure of a wireless protocol to execute on a first processor of the wireless device; and
scheduling, via the multi-level scheduler, a first periodic procedure of the wireless protocol to execute on a second processor of the wireless device, wherein the first processor is in a low power state during at least a portion of the execution of the first periodic procedure on the second processor.

19. The computer readable medium of claim 18, wherein the method further comprises:
arbitrating between a second non-periodic procedure and the first periodic procedure to identify a selected procedure and a non-selected procedure; and
scheduling, via the multi-level scheduler, the selected procedure to execute on the second processor, the second processor comprising a co-processor and the first processor comprising a host processor.

20. The computer readable medium of claim 18, wherein the method further comprises scheduling the first periodic procedure to execute on the second processor in an interleaved manner with a second non-periodic procedure to execute on the second processor.
